(19) United States
(12) Patent Application Publication
(10) Pub. No.: US 2005/0282125 A1
(43) Pub. Date: Dec. 22, 2005

(54) Individualized retention plans for students

(76) Inventors: Coray Christensen, Cedar Hills, UT (US); Terry Ulanch, Salt Lake City, UT (US); James Aalen, Salt Lake City, UT (US)

Correspondence Address: SNELL & WILMER;ONE ARIZONA CENTER, 400 EAST VAN BUREN, PHOENIX, AZ, 850040001, US

(21) Appl. No.: 10/870,099

(22) Filed: Jun. 17, 2004

(51) Int. Cl. G09B 19/00

(52) U.S. Cl. 434/219; 434/236

(57) ABSTRACT

Developing and executing individualized retention plans for students. A career success survey is provided to a student, and the survey includes queries used to derive a student vulnerability index. A completed version of the career success survey with answers to the queries is received from the student, and an communication plan is assigned to the student based the completed career success survey (student vulnerability index). The dynamically assigned communication plan delivers messages to the student at periodic times in an effort to increase the likelihood of retaining the student or otherwise attempt to prevent the student from dropping out of an educational institution. The messages can include e-mail, mail, and telephone messages, and they can be sent at particular times during the student's enrollment at the educational institution. The content of the messages are personalized to the student based upon a number of criteria such as age, major, gender, identified needs, student vulnerability index, or any other criteria gathered by the system from the career success survey. The system also provides the basis of a student retention methodology for school administrators, faculty and staff by providing an environment for all concerted to better understand who the at risk students are, how to best help the at risk students, and a reporting system indicating improvement in student retention.

### FIELD OF THE INVENTION

The present invention relates to a standardized apparatus and method for developing and assigning retention plans which improve student retention rates at educational institutions.

### BACKGROUND OF THE INVENTION

Educational institutions can suffer a loss of revenue when students drop out of enrollment in them. In particular, they experience a loss in tuition revenue, as well as possibly a negative perception in terms of graduation rates. The reasons for students to leave educational institutions cover a wide variety of issues depending upon each student's situation. The educational institutions currently have no standard way to address these issues for the students, and they are thus left on their own to resolve any of the issues that may otherwise cause the students to leave the institutions.

Accordingly, a need exists to develop an individualized and proactive retention plan for students or others.

### SUMMARY OF THE INVENTION

A method and apparatus consistent with the present invention provide for developing and executing individualized retention plans for students. In the method and apparatus, a career success survey is provided to a student, and the survey includes queries used to derive a student vulnerability index. A completed version of the career success survey with answers to the queries is received from the student, and an individualized retention plan is assigned to the student based upon the student vulnerability index. The individualized retention plans can include messages in the form of email, letter, and phone calls are sent to the student, at periodic times, in an effort to increase the likelihood of retaining the student or otherwise attempt to prevent the student from dropping out of an educational institution. School administrators and faculty members can also use the student vulnerability index to identify at risk students whom they can focus their attentions on in an effort to keep these at risk students in school. Furthermore, metrics about the retention plan and related student demographics are made available in numerous report formats, which are also used by the school administrators and faculty members to focus their attentions in an effort to keep students in school.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram conceptually illustrating an overview of the methods and apparatus consistent with the present invention;

FIG. 2 is a conceptual diagram of a the creation and structure of the Career Success Survey and its use within the methods and apparatus;

FIG. 3 is a flow chart of methods used to implement the Career Success Survey;

FIG. 4 is a flow chart of a method for developing initial SVI rankings used to assign communication retention plans;

FIG. 5 is a flow chart of a method for refining the SVI rankings based on historic data within system;

FIG. 6 is a flow chart of a method used by school administrators, faculty, and staff to focus student retention issues using the propose system; and

FIG. 7 is a diagram of an exemplary network for use in implementation of the methods and apparatus in one particular embodiment.

### DETAILED DESCRIPTION

### Introduction

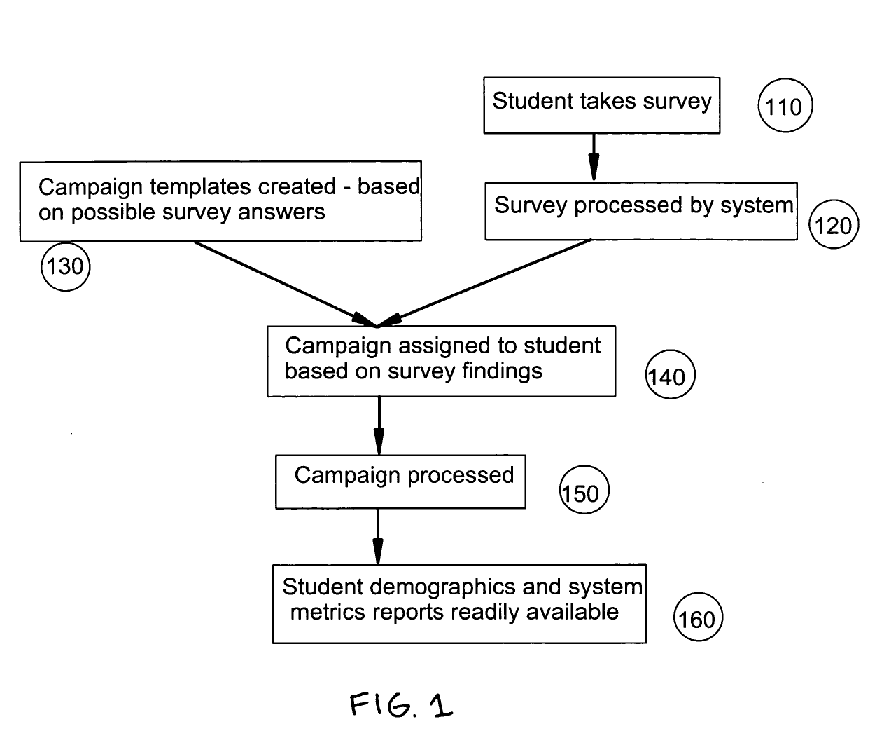

FIG. 1 is a diagram conceptually illustrating an overview of the method and apparatus used to retain students. A student upon enrollment 110, for example, fills out and provides a completed career success survey. The career success survey typically includes a series of questions or queries, the answers to which provide an indication of a student's vulnerability in terms of dropping out of an educational institution. The term “career success survey” includes any way to obtain information from students providing an indication of their risk in dropping out of an educational program. The career success survey can be administered in either electronic or paper based format. The paper based format is scanned and converted into the same format as the electronic version prior to being submitted to the processing engine. Based upon the completed career success survey, the administrator of the processing engine 120 develops a student vulnerability index. A number of campaign templates are created 130 based upon expected student vulnerability indexes, for example HIGH, MEDIUM, and LOW SVI values. One or more of these pre-defined plans are automatically assigned 140 to the student based on defined criteria such as their student vulnerability index. According to the student individualized retention plan 150 (communication plan), processing engine sends periodic messages to student, and the messages are designed to help ensure retention of the student at the educational institution.

The term “career satisfaction survey” includes any way to obtain feedback information from students concerning their individualized retention plans. All of the message deliveries, status changes of students, retention metrics, student vulnerability values, and other system metrics are 160 available to school administrators and faculty members. This information is used to improve their retention practices at the school and is also used to improve the process going forward in a proactive manner.

Appendix A includes an example of a Career Success Survey, and Appendix B includes an example of a Career Satisfaction Survey. These exemplary Surveys are provided for exemplary purposes only, and other Career Success Surveys and Career Satisfaction Surveys can include fewer questions, additional questions, different questions, and different student range or responses for the questions.

### Use of Career Success Survey and SVI value

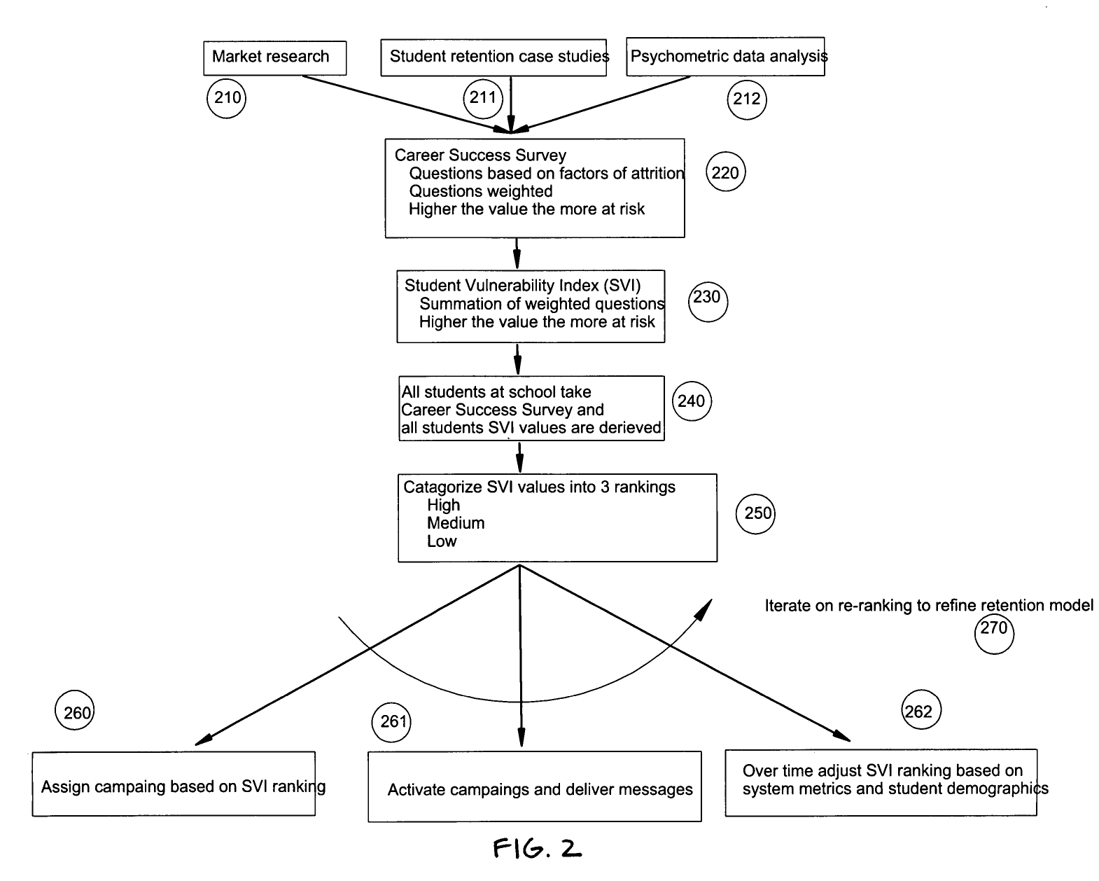

FIG. 2 is a conceptual diagram of a the creation and structure of the Career Success Survey and its use within the apparatus and methods. Extensive analysis of Market Research 210 along with numerous Student Retention Case studies 211, and Psychometric analysis 212 of related data was combined into a series of questions. These questions have allowable answers ranging from 220 Completely Agree to Completely Disagree with other suitable answers in between. The questions were found to be leading factors of student attrition. These questions were ranked and weights were assigned accordingly. The rankings and weighting can be assigned based upon empirical evidence such as market research and analysis of trends among students. For example, the higher the weight the more relevant the question was found to be to student attrition. A Student Vulnerability Index (SVI) 230 is created by summating the resulting weights based on the answers a student provides to the survey. All students at a school take the Career Success Survey 240 and a SVI value is obtained for each of them. These SVI values are further analyzed and group into categories of, for example, HIGH, MEDIUM, and LOW rankings 250. One or more of the pre-defined messaging campaigns are assigned to the students based upon their SVI value 260. These campaigns deliver messages in the form of email, letters, or phone calls. The communications can include any combination of those three communication methods and possibly other types of messages and ways for communication of them. Also, different types of categories for the rankings can be used as well.

The contents of the messages are personalized to the student. Any Customer Relationship Management (CRM) 261 product can be used to facilitate the delivery of these messages. Over time 262 further analysis is performed on the stored system metrics and student demographics—specifically on the dropped students data to refine the SVI rankings. The process of assigning campaigns, acting upon the assigned campaigns, and re-evaluating the SVI values is an interactive process that can occur numerous times 270, until a point where the predictability of the system is extremely accurate and the retention model for the school is well defined.

### Implementation of Career Success Survey

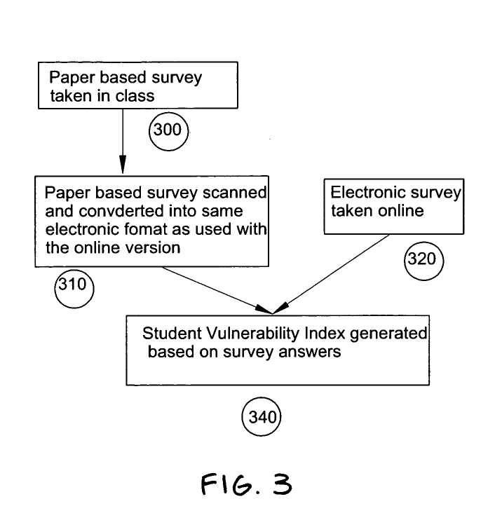

FIG. 3 is a flow chart of methods used to implement the Career Success Survey. Since certain schools have limited access to the Internet, specifically with the students, the methods can include both a paper based version 300 and an online version 320 of the Career Success Survey. The paper based survey is a typical fill in the dot type survey, an example of which is provided in Appendix A. This survey is then scanned in 310 and converted into electronic format—the same electronic format as provide by the online version of the survey. The electronic format of the survey 340 is used by the system to create the SVI values.

### Initial SVI Value Ranking

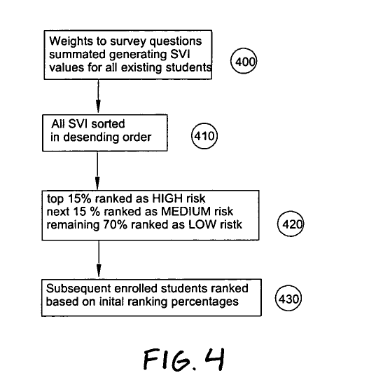

FIG. 4 is a flow chart of methods used for initially defining the SVI rankings. Initially, all students, both currently active and students who are just enrolling take the Career Success Survey 400 and SVI values are obtained for all of these students. These SVI values are listed in a 410 descending order from highest SVI value to lowest SVI value. From empirical evidence such as market research and analysis, generally speaking, 15% of students are highly susceptible to attrition, the next 15% are moderately, and the remaining 70% are mildly susceptible to attrition. The methods initially rank 420 the top 15% as HIGH risk students, net next 15% as MEDIUM risk students and the remainder as LOW risk students. This initially ranking system 430 is used for all subsequent enrolled students. The percentages can thus be used to identify at risk students in terms of those students likely to drop out of school. Other percentages for the rankings can be used, depending upon particular implementations or other empirical evidence.

### SVI Value Ranking Refining

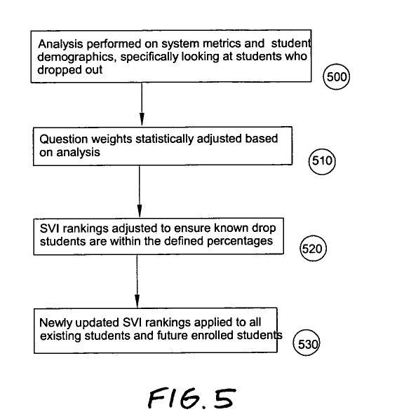

FIG. 5 is a flow chart of a method for refining the SVI rankings based on historic data within the system. Over time the predictive aspect of the system is refined. This begins by performing basic statically analysis on 500 on the data which is continually added to the system. This analysis specifically focuses in on the dropped students. The dropped students demographics, SVI values, and survey answers are analyzed to refine the SVI values. The weights of the questions need to be adjusted 510 to begin this update. The more statically important questions (when viewed against the dropped students) receive greater weight values, the less statistically important question receive lower weighting values. New SVI values are then derived based using these new weights 520 and new SVI rankings levels are set. Once the new rankings are set, the system 530 uses these new ranking values to assign campaigns to new and appropriate existing students.

### Establishment as School Retention System

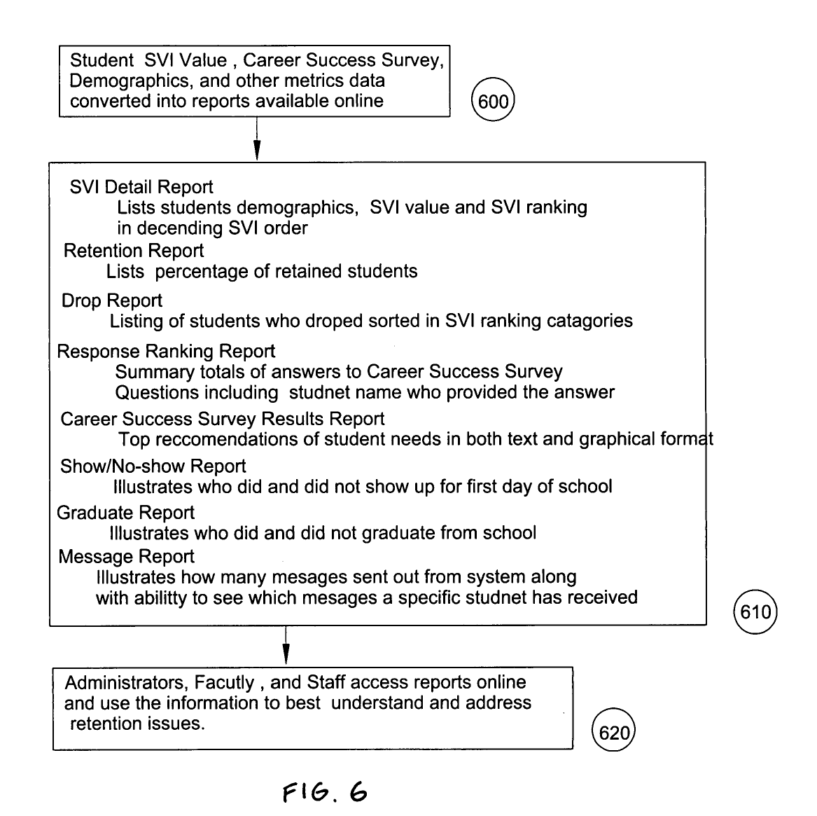

FIG. 6 is a flow chart of a method used by School administrators, Faculty, and Staff to focus student retention issues using the propose system. Empirical evidence such as market research has indicated that there is no standardized system for student retention, yet the problem is ubiquitous within the industry, as described above. The approach to solving this problem is similar to quality improvement processes used to re-engineer business or in manufacturing quality improvement. All of these improvement systems require the measurement of key indices to measure the improvement. This system gathers key student retention indices 600 such as student demographics, number of messages sent, Career Success Survey answers, SVI values and rankings to name a few. This information is dynamically converted into a number of standard reports 610. These reports allow school administrators, faculty, and staff to quickly and efficiently understand who the high risk students are. This knowledge allows them to focus their valuable recourses on these students to better improve retention rates. Other reports in the system provide metrics which prove the system is operating, for example an increase in graduation rates and a decrease in student dropout. These reports 620 are readily available and can provide an indication of retention success in terms of, for example, indicating trends in student drop out and graduation rates.

### Network

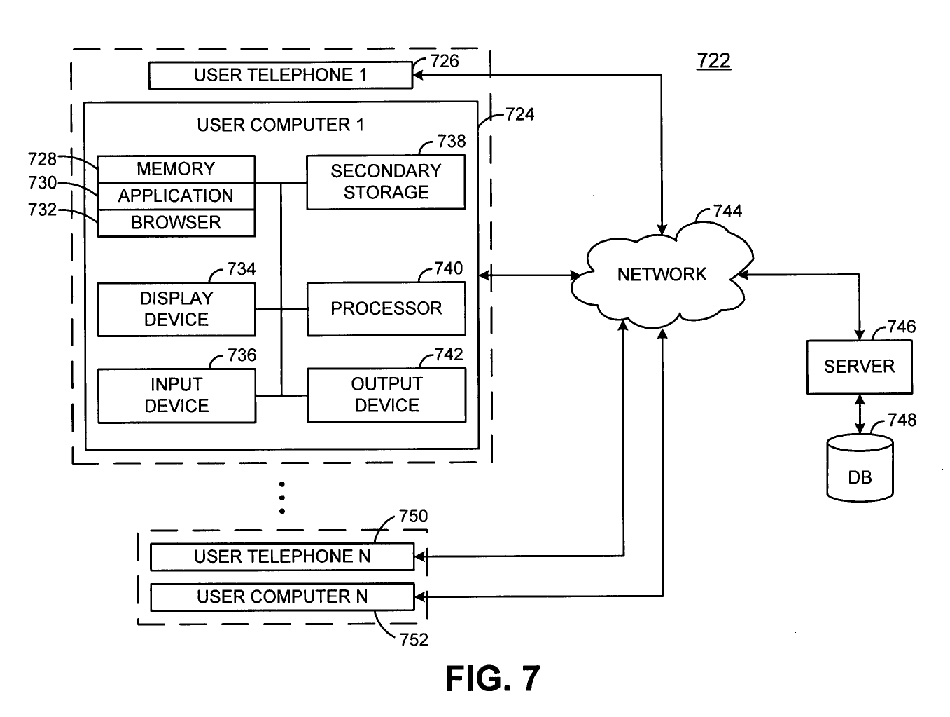

FIG. 7 is a diagram of an exemplary network for use in implementation of the methods and apparatus in one particular embodiment. This exemplary network can be used by users, such as administrators, faculty, and staff of an educational institution, for the methods described above, when implemented within a computer-based network of computers or other computing devices executing the methods using software modules, for example. Alternatively, the methods and apparatus can be implemented in other ways, such as by use of paper based communication, mail communication, or other ways of communication.

An exemplary network-based implementation 722 can include multiple user computers 724 and 752, associated with user telephones or other communication devices 726 and 750. An exemplary user computer may include a memory 728 storing one or more applications 730 and a web browser 732, a secondary storage device 738, a processor 740 for executing applications, a display device 734, an input device 736, and an output device 742. The user computers and telephones can provide for communication over a network 744, such as the Internet or other communications network, with a server 746 or other devices, and server 746 can include an associated database 748 for storing individualized retention plans, for example, or other information.

While the present invention has been described in connection with an exemplary embodiment, it will be understood that many modifications will be readily apparent to those skilled in the art, and this application is intended to cover any adaptations or variations thereof. For example, different components for the various computers, communication methods, index values, and templates may be used without departing from the scope of the invention. This invention should be limited only by the claims and equivalents thereof.

1. A method for developing and executing individualized retention communication plans for students, comprising:
providing to a student a career success survey, the career success survey including a plurality of queries used to derive a student vulnerability index;
receiving from the student a completed version of the career success survey with answers to the queries generating the student's individual student vulnerability index;
dynamically assigning an individualized retention plan to the student based upon the completed career success survey results and the individual student vulnerability index; and
sending messages, at periodic times, to the student based upon the student's career success survey answers and the individualized retention plan.

2. The method of claim 1, further including:
receiving from a plurality of students individualized answers to the career success survey;
determining from the individualized answers a listing of at risk students among the plurality of students; and
reporting the listing of at risk students.

3. The method of claim 1, further including ranking the student, among a plurality of students, based upon the individual student vulnerability index.

4. The method of claim 3, further including refining the student's ranking based upon particular criteria.

5. The method of claim 1, further including:
providing the student with a career satisfaction survey; and
receiving answers to the career satisfaction survey by the student.

6. The method of claim 5, further including generating a report, providing an indication of retention success, based upon the student's answers to the career success survey and the career satisfaction survey.

7. A system for developing and executing individualized retention communication plans for students, comprising:
a module for providing to a student a career success survey, the career success survey including a plurality of queries used to derive a student vulnerability index;
a receive module for receiving from the student a completed version of the career success survey with answers to the queries generating the student's individual student vulnerability index; and
an assign module for dynamically assigning an individualized retention plan to the student based upon the completed career success survey results and the individual student vulnerability index; and
a send module for sending messages, at periodic times, to the student based upon the student's career success survey answers and the individualized retention plan.

8. The system of claim 7, further including:
a module for receiving from a plurality of students individualized answers to the career success survey;
a module for determining from the individualized answers a listing of at risk students among the plurality of students; and
a module for reporting the listing of at risk students.

9. The system of claim 7, further including a module for ranking the student, among a plurality of students, based upon the individual student vulnerability index.

10. The system of claim 9, further including a module for refining the student's ranking based upon particular criteria.

11. The system of claim 7, further including:
a module for providing the student with a career satisfaction survey; and
a module for receiving answers to the career satisfaction survey by the student.

12. The system of claim 11, further including a module for generating a report, providing an indication of retention success, based upon the student's answers to the career success survey and the career satisfaction survey.

13. A method for developing and executing individualized retention communication plans for students, comprising:
providing to a plurality of students a career success survey, the career success survey including a plurality of queries used to derive student vulnerability indexes;
receiving from the students a completed version of the career success survey with individualized answers to the queries generating an individual student vulnerability index for each of the students;
ranking each of the students, among the plurality students, based upon each the student vulnerability index for each of the students
dynamically assigning an individualized retention plan to each of the students based upon the individual student vulnerability index and the ranking for each of the students; and
sending messages, at periodic times, to the students based upon the student's career success survey answers and the individualized retention plan.

14. The method of claim 13, further including:
providing each of the students with a career satisfaction survey; and
receiving individualized answers to the career satisfaction survey by the students.

15. The method of claim 14, further including generating a report, providing an indication of retention success, based upon the answers to the career success survey by each of the students and the answers to the career satisfaction survey by each of the students.
